(19) United States
(12) Patent Application Publication
(10) Pub. No.: US 2002/0046146 A1
(43) Pub. Date: Apr. 18, 2002

(54) Apparatus, methods and articles of manufacture for constructing and executing computerized transaction processes and programs

(76) Inventors: Hernan G. Otero, Huntington, NY (US); Steven B. Horn, New York, NY (US); John Tumilty, New York, NY (US)

Correspondence Address: DILWORTH PAXSON LLP, 3200 MELLON BANK CENTER, 1735 MARKET STREET, PHILADELPHIA, PA, 19103, US

(21) Appl. No.: 09/773,139

(22) Filed: Jan. 31, 2001

Related U.S. Application Data
(60) Provisional application No. 60/241,807, filed on Oct. 14, 2000.

(51) Int. Cl. G06F 17/60

(52) U.S. Cl. 705/37

(57) ABSTRACT

Open-ended apparatus, methods and articles of manufacture for constructing and executing transaction processes and programs are shown. These apparatus, methods and articles of manufacture are primarily used in computerized trading processes.

### CROSS-REFERENCE TO RELATED APPLICATIONS

This application is related to provisional application U.S. Ser. No. 60/241,807, by Steven B. Horn, John A. Fanelli, Hernan G. Otero and John Tumilty, which disclosure is incorporated herein by reference.

### FIELD OF THE INVENTION

This invention relates to apparatus, methods and articles of manufacture for computerized transaction execution and processing. More particularly, this invention relates to apparatus, methods and articles of manufacture for client-server transaction execution and processing.

### BACKGROUND OF THE INVENTION

Computerized transaction execution and processing requires an enormous, and often detrimental, amount of time and resources. The time and resources are required because, in most instances, execution and processing are based upon customized implementations of the transaction.

Customized transaction implementations require new programming. New programming requires cost and effort—not only for the first attempt, but also for the debugging and testing processes. Moreover, once the program is debugged and released, real world implementations require yet further testing and debugging.

All this effort takes resources and time. It takes resources because the programmers must first develop the program with input for the uses, and then the users themselves must test the program in the field, to ensure reliable operation. The effort required means that the users may be too busy doing their job to assist in programming efforts. Thus the program may not ever be developed. Moreover, by the time any particular program is developed, the markets may have shifted away from the initial transactional conditions that first provided the impetus for developing the program. For example, specific trading strategies are usually constructed and executed on a customized basis, yet by the time the program is developed for those strategies, and those strategies are executed, they may be no longer useful.

The cost, effort and time factors are not solely the result of required programming. In trading transactions, the programmers must be advised by the traders or other business professionals regarding desired trading strategies and desired markets. These professionals are busy in their own right—they may have little or no time to advise the programmers on what new strategies and markets should be developed. Even if they can advise the programmers, trading strategies can become quite complex, and in order to communicate those strategies and implement those strategies effectively, the programmer and trader interactions cost time, money and resources.

Enterprise-wide customization adds yet another level of time, effort and complexity. What may be useful in one enterprise business unit may not be useful in another, and time, effort and resources may not be available to implement specific programs customized for each business unit.

Finally, any implementations must be quite robust, and reliably and consistently execute trading strategies. The implementation of new computerized transactional programs must be as close to bullet proof as possible—failure of a trading programs can mean losses in thousands, millions or even billions of dollars. Developing reliable implementations of trading programs means that testing procedures and recovery procedures must always be paramount considerations.

Accordingly, it is an object of this invention to provide apparatus, methods and articles of manufacture for constructing and executing transactions.

It is a further object of this invention to provide open-ended apparatus, methods and articles of manufacture for constructing and executing transaction processes and programs.

It is a further object of this invention to provide robust and reliable apparatus, methods and articles of manufacture for implementing trading strategies.

### BRIEF DESCRIPTION OF THE DRAWINGS

FIG. 1 is a schematic diagram of a preferred embodiment.

FIG. 2 is a schematic diagram of a preferred embodiment.

FIG. 3 is a screen shot of a preferred embodiment.

FIG. 4 is a screen shot of a preferred embodiment.

FIG. 5 is a screen shot of a preferred embodiment.

FIG. 6 is a schematic diagram of a preferred embodiment.

FIG. 7 is a schematic diagram of a preferred embodiment.

FIG. 8 is a flow chart of a preferred embodiment.

FIG. 9 is a flow chart of a preferred embodiment.

### SUMMARY OF THE INVENTION

The present invention provides apparatus, methods and articles of manufacture for open-ended construction and execution of computerized transaction processes. In the preferred embodiments, an engine is used that permits “plug-ins” to be used for construction, modification and alteration of trading procedure execution. These plug-ins can be pre constructed, or constructed when appropriate, and applied to the engine when desired.

In the preferred embodiments, the plug-ins comprise two types. The first type comprise algorithms used in trading. The second type comprise market-specific rules. Thus, for example, in the preferred embodiments, the engine can be configured with a specific algorithm and for a specific market for a first trade and then modified for another specific algorithm and another specific market for a second trade. In the especially preferred embodiments, the engine will carry out a number of trades using a specific algorithm, which has been chosen from a set of preconfigured algorithms. Moreover, the market plug-ins, having been set upon installation for use in a particular market, will be maintained for a predetermined or static period of time.

### DETAILED DESCRIPTION OF THE PREFERRED EMBODIMENTS

The preferred embodiments of the present invention provide apparatus, methods and articles of manufacture that have a number of characteristics in order to provide open-ended construction and execution of computerized trading processes. The preferred embodiments are constructed in Java which is essentially a platform independent language. Standard Java features are used in order to permit consistency among various Java versions. Javadocs, as well as the tracking application CVS, permits convenient tracking of modifications and revisions of these embodiments. Of course, other embodiments may be translated into other languages. Therefore, the embodiments may be used across a wide variety of networked platforms.

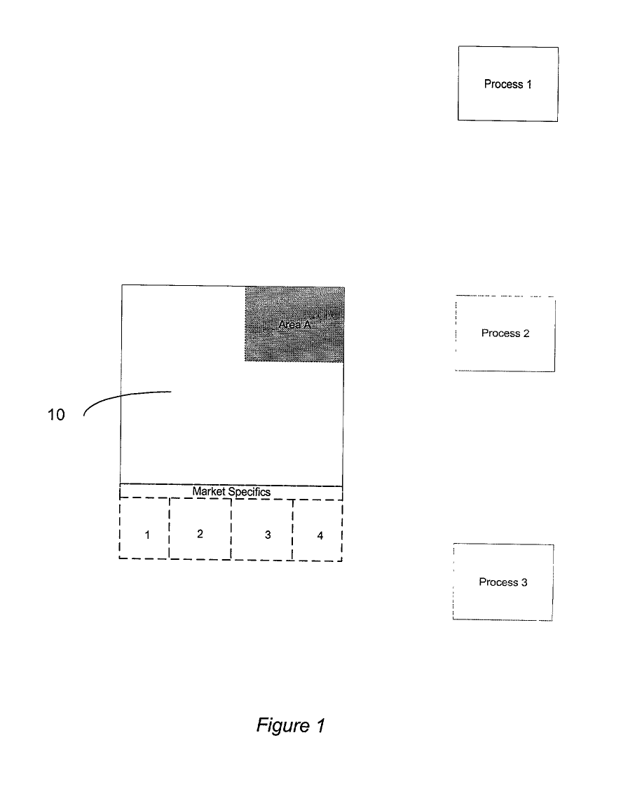

FIG. 1 shows a schematic diagram of a preferred embodiment. At 10 is shown the engine infrastructure of the preferred embodiment. Written in Java, and present on the server, this software enables various data, plug-ins, applications, processes, and algorithms to be used in order to customized the trading process. These data, plug-ins, applications, processes, and algorithms are imported or plugged into the engine as desired in order to implement a particular trading strategy.

Seen in FIG. 1 are various processes to be used in the engine 10. Area A of engine 10 symbolizes the area in which the plug-ins can be placed. Also seen at 10 is an area labeled “Market Specifics.” This area, also supporting customization through data, plug-ins, applications, processes, and algorithms permits customization of any particular algorithm for any particular market in a manner explained in further detail below. In other embodiments, the plug-ins used for the various areas can be internal or external to the engine. Hereinafter, “plug-ins” will be used as a general term for data, plug-ins, applications, processes, and algorithms.

Engine 10, in this embodiment, provides services for the plug-ins. For example, most trading strategy plug-ins will need to access market data. Most trading strategy plug-ins will need to send orders to the exchange and be notified of executions, etc. Engine 10 provides these and other services to the plug-ins. For example in a preferred embodiment, engine 10 provides:

A real time market data feed driver (e.g. Reuters SSL, TIB/Rendezvous feeds.)

An exchange driver where the algorithm sends orders and receives executions back.

A driver implementation that sends orders to one or more order management architecture(s) and/or system(s) server(s) is provided.

An input driver which enters requests to the engine 10.

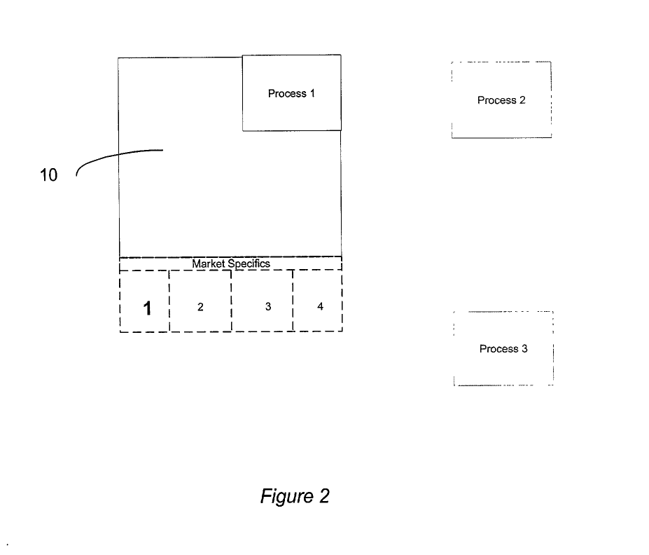

FIG. 2 shows Process 1 implemented in engine 10. Process 1 might be a trading process such as Volume-Weighted-Average-Price or VWAP. The VWAP algorithm used in this embodiment, attempts to match the VWAP for a given instrument, such as an equity throughout a specified lifespan (e.g. throughout the full trading day). VWAP will maintain a number of limit orders in the market at different price levels. In order to trade according to the VWAP algorithm of this embodiment, the engine will listen to market data throughout the day and access a volume profile to match the day's VWAP as close as possible.

The trader will then be able to review, thorough his screen, the order as it is being executed according to the VWAP algorithm. Any updates and/or changes will be simply made through his or her screen.

If a second VWAP algorithm was desired to be used, such as one that is based on theoretical values to trading, this second plug-in can be substituted for the first in the engine. This second plug-in will then be used by the engine.

Returning to FIG. 2, the Market Specifics plug-in 1 has been chosen. Market specifics provide specific variables, data and other plug-ins necessary for the specific market in which the embodiment is being used. For example, they may be different limits on trading volume in one market versus another. The preferred embodiments permit configuration and modification of these Market Specifics, by plug-ins, so that they may be used in a variety of markets as desired.

In the preferred embodiments, the plug-ins comprise two types. The first type comprise algorithms used in trading. The second type comprise market-specific rules. Thus, for example, in the preferred embodiments, the engine can be configured with a specific algorithm, such as a first VWAP algorithm and for a specific market for a first trade such as the New York Stock Exchange and then modified for another specific algorithm such a Ratio algorithm and another specific market such as the Tokyo Stock Exchange for a second trade. In the especially preferred embodiments, the engine will carry out a number of trades using a specific algorithm, which has been chosen from a set of reconfigured algorithms. The algorithm used may be parameterized by the trader, in order to execute specific trades for a specific stock, price and number of shares. In these embodiments, the algorithm plug-in used is usually consistently used for that implementation of the embodiment during that particular trading period—whether it be an hour, day, week, etc. Of course, other embodiments may change their algorithm during any particular trading period. Moreover, the especially preferred embodiments usually maintain the market plug-in for at least the trading period, and usually longer. A trader, for example, may trade exclusively on the New York Stock Exchange using a preferred embodiment. Note that, using the especially preferred embodiments, the trader will change the algorithm plug-in, embodying his or her trading strategy, much more frequently than his or her market plug-in, as he or she may only trade in a particular market. Network or enterprise wide implementations, however, will use the market plug-in order to configure any particular implementations for traders in the various trading markets.

This embodiment also effectively provides real-time monitoring of the order by the trader as well as others such as the sales force who desire to monitor the order and its execution. Additionally, orders are fully integrated, and so the trader or others may override individual orders through the system of this embodiment, without an additional messaging system. Similarly, any changes to an order, such as size of the order or a price limit or volume can be echoed to the system of this embodiment and the system will automatically adjust its trading to the new parameters.

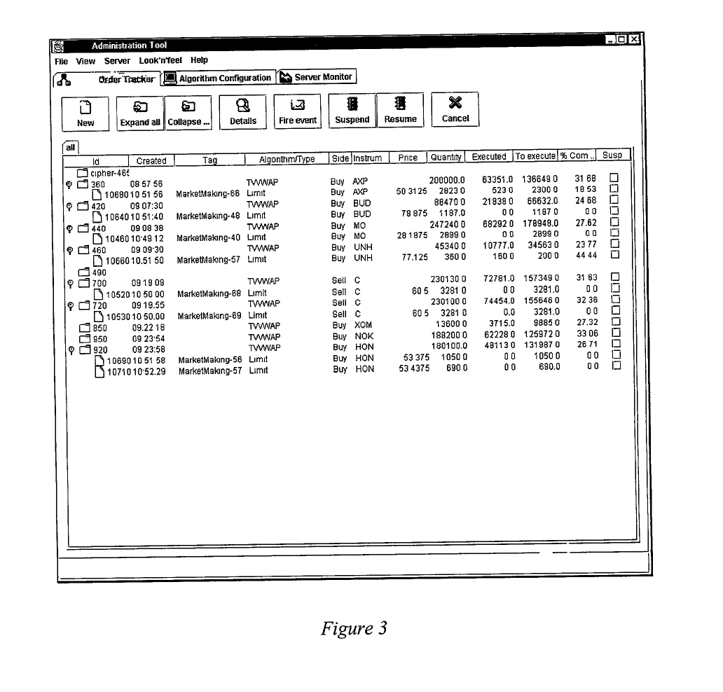

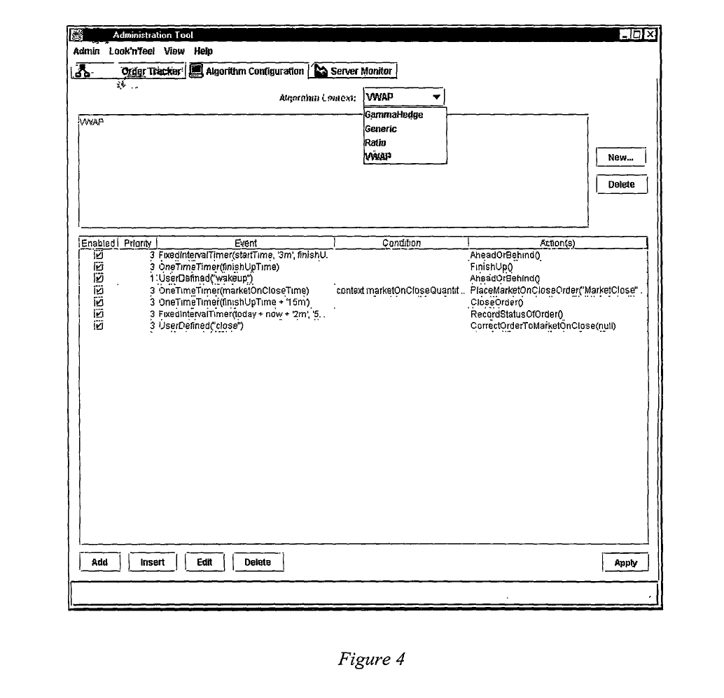

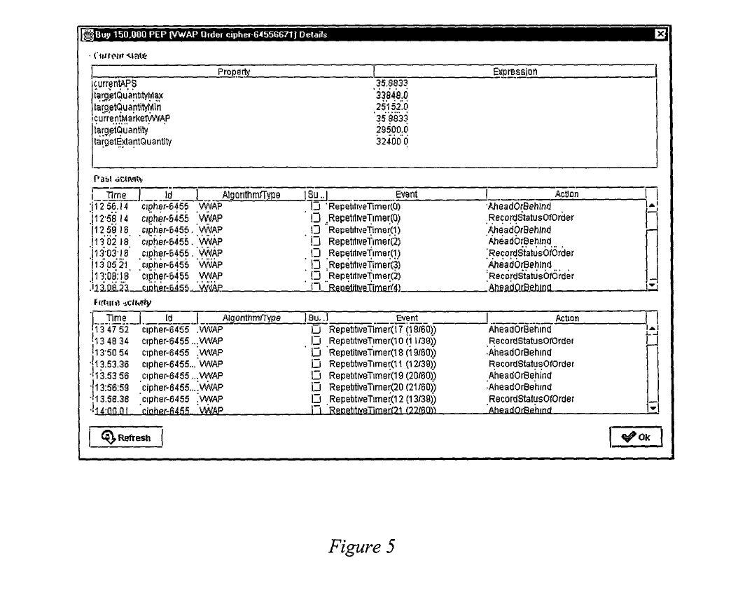

Various screen shots of the administration and monitoring tool GUI (written in Java, using Swing) used in a preferred embodiment are shown at FIGS. 3 through 5. These are an Order Tracker screen shown in FIG. 3, an Algorithm Configuration screen shown in FIG. 4, and an Order Details screen shown in FIG. 5. This tool allows for configuring algorithms as well as monitoring the server. This tool may be installed on either or both of the client and server machines and on more than one machine in the networked environment.

In the preferred embodiments, an algorithm is comprised of an Algorithm Context, which may be a Java Class, plus a set of event-action mappings. These algorithms are usually written by a programmer. The mappings may be modified by nonprogrammers (e.g. a trader) via the graphical tool. The mappings provide a powerful way to fine tune the algorithm. Of course other embodiments may modify the mappings in a different fashion. For example, the programmer may provide the trader or other end user with objects that constitute events, conditions and actions. The trader can then construct his or her own algorithms which are plugged into the invention in order to provide the trader with an automatic execution mechanism.

Other algorithms that may be used in this embodiment include:

Ratio which tries to buy an instrument and sell a related instrument when the price between the two is more favorable than a specified ratio.

Gamma Hedge which hedges a portfolio and tries to capture volatility while doing so.

Aggressive Short Sell which tries to short sell a given instrument by making sure the Tokyo short sell rule is not violated.

Stop Loss which allows sending stop loss orders to exchanges that do not support this concept.

Iceberg which tries to trade a specified number of shares by sending only a part of the total order's quantity (the tip of the iceberg) to the market at any given time.

Auto Trader which decides whether to send trades to the market or fill from an account.

CB Delta Hedge which sends out underlyer market orders to hedge CB trades.

Of course, other algorithms or plug-ins may be used. Additionally, in the preferred embodiments, preferred methods of constructing and implementing new plug-ins are used. The preferred embodiments also use several Java features, e.g. introspection, reflection and the like, in order to automatically discover properties of the imported algorithms.

If new algorithms are desired, a number of methods can be used to create the algorithm. In this embodiment, if the new algorithm requires no Java code, then the algorithm can be created by leveraging on existing algorithm context classes. Specific classes have been established or predetermined in the preferred embodiments. If the new algorithm is simple enough, it can be created without writing any Java code, making use of the Administrator GUI. This can be done by simply creating a set of event-action mappings that will work on a pre-existing algorithm context class (e.g. the base AlgorithmContext class that is part of the preferred embodiments code classes).

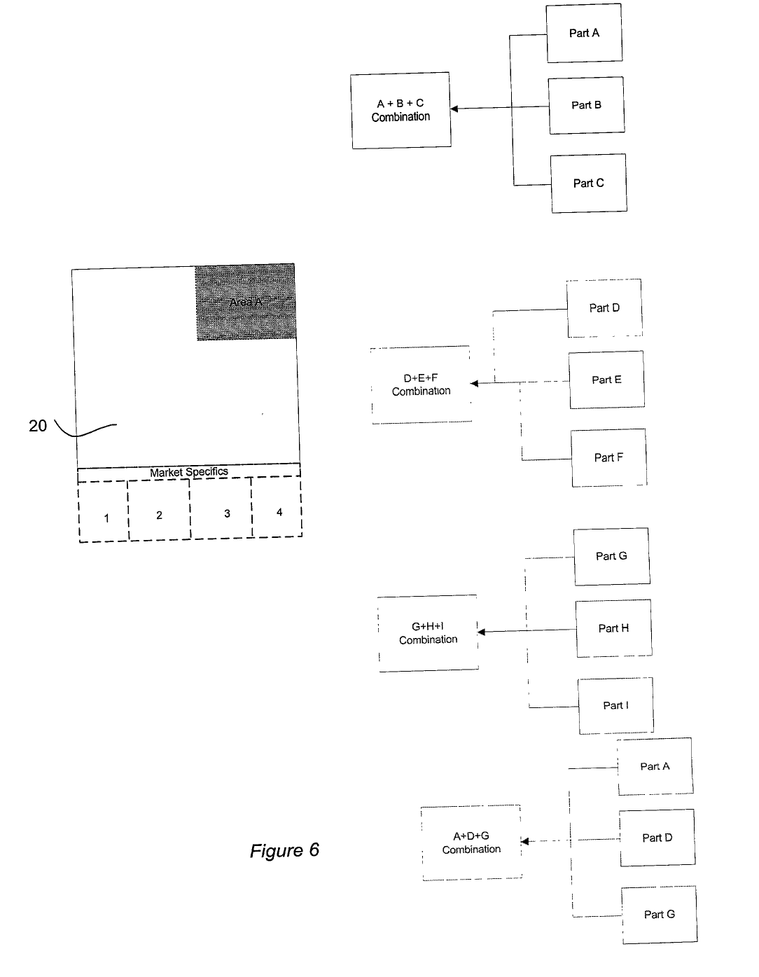

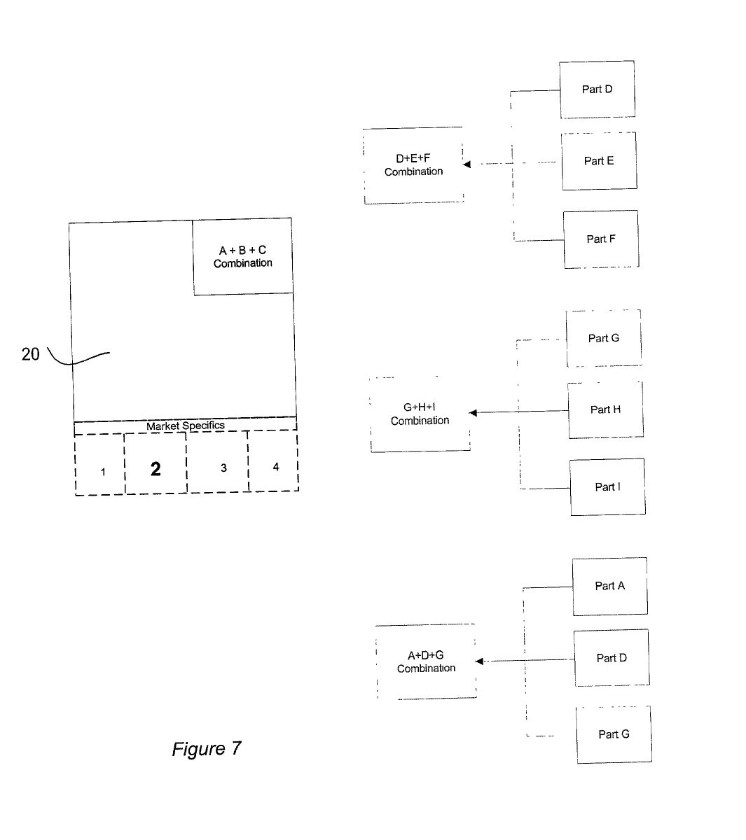

FIGS. 6 and 7 show how various mappings or parts may be used to construct combinations. Those combinations, constructed in FIG. 3, are then inserted into the engine 20 in FIG. 7. Note that a different Market Specifics plug-in, Market Specifics 2, has been chosen in FIG. 7. These Market Specifics plug-ins may be from a predetermined set or constructed “on the fly.” In the especially preferred embodiments, the market plug-in is usually maintained over some static trading period. A trader, for example, may trade exclusively on the New York Stock Exchange, using the market plug-in. In enterprise installations, the market plug-ins may be set for the particular trading markets across the enterprise, and remain as set for a predetermined or static period of time.

If the new algorithm requires writing new code, the fundamental classes within the architecture of the preferred embodiment are: AlgorithmContext, Action, ActionBindings, ActionDispatcher. New Actions might be needed, for new complex algorithms, in order to do simple tasks that the existing actions can not deal with. Algorithms which require saving state during the execution of the order, for example, need to have their own Algorithm Context subclass. The data will then be kept in this new subclass.

The following process is used in the preferred embodiment to write code for a new algorithm. A Simple Algorithm Context must be written, starting with a template of what the class should look like, providing an empty, public constructor, adding in member variables, and providing a public getter/setter pair. Since this preferred embodiment makes use of beans support classes to access properties, JavaBeans conventions are used when naming these methods.

It is important to note that, in the preferred embodiments, traders provide vital feedback and oversight. Moreover, the embodiments evolve through use. There may be a lengthy tuning and feedback phase of algorithm development. The embodiments fit within a scalable architecture, and as the algorithms become more complex and widely used, the embodiments adapt and scale. Additionally, the embodiments must have fast Release Cycles. The preferred embodiments are flexible and separate the algorithm from the engine. Also, the algorithm should be as orthogonal as possible to the rest of the system. By use of this structure in the preferred embodiments, the embodiments can be used to trade and transact across virtually any instruments or exchanges.

In the preferred embodiments, the algorithms are tested for use. Of course, in other embodiments testing may not be desired. There are two main testing stages in a preferred embodiment. The first stage involves soliciting feedback with the traders and salespeople using the algorithm. The algorithm will not work right the first time, situations will not have been thought of, parameters will be wrong, failsafes will not be good enough and so on. The feedback at this early stage of development ensures not only a quick release but also that modifications can be made in situ.

The second stage of testing in this embodiment involves the continued evolution and updating of an algorithm once it is in production. It is important to have a very extensive series of tests that cover a multitude of trading situations. When changes are made to an algorithm, no matter how slight, every test is run and verified. This is necessary for production systems with a large number of users. Without high confidence that any changes made will not have any unforeseen follow-on effects, the release cycle becomes intolerably long. Of course, other embodiments may utilize different testing methods, including providing sample market feeds rather than real time feeds. The term “executing a trade” and its variants as used herein is meant to cover both actual and simulated execution of a trade.

The preferred embodiments implement a recovery mechanism, which assists the programmer in analyzing and/or recovering from crashes. The recovery process restores execution of orders by taking a number of steps. Those steps comprise:

Recovering the state of the orders. This involves rebuilding the order hierarchy (parent/child relationships, executed quantities, etc.) as it existed prior to the crash.

Recovering the exchange information. This involves making sure that all executions/corrections/cancellations that might have been pending when the embodiment crashed and had taken place during its blackout now get reflected in the embodiment's order hierarchy. This is done so that future algorithm decisions get based on the current state of the world, and not the one present before the crash.

Restarting all algorithms. This is now possible since the algorithms will have their information up-to-date in order to make correct decisions on how to continue their execution. Depending on the complexity of the algorithms involved, this step may be as simple as setting up the eventaction mappings for the algorithm context.

The recovery process in this embodiment includes writing to log or journal file. Of course other embodiments may have other recovery processes or recovery steps.

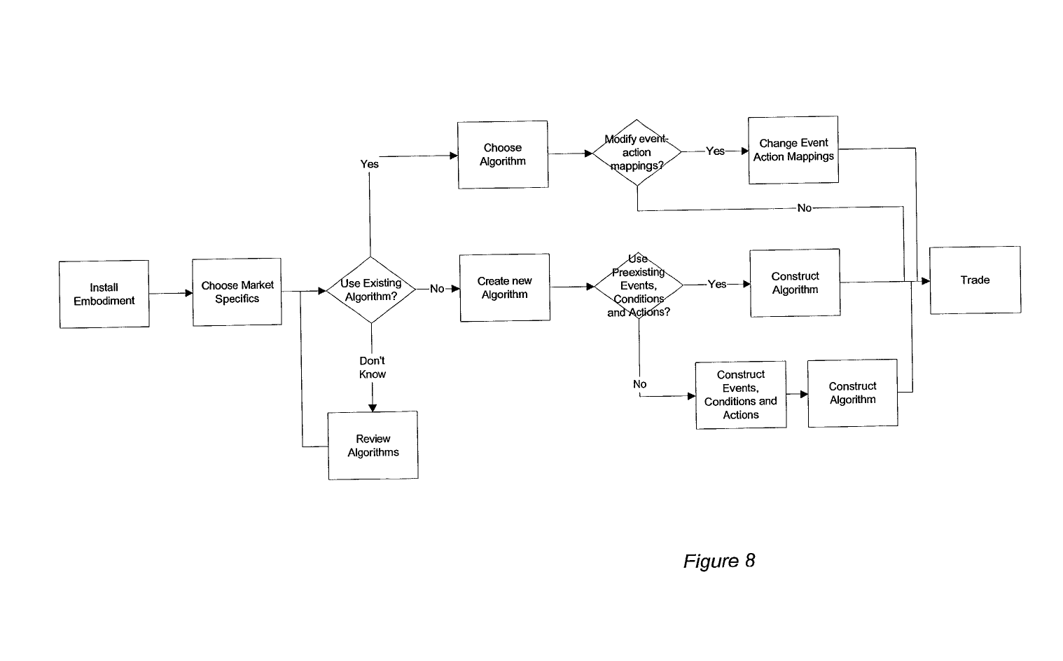

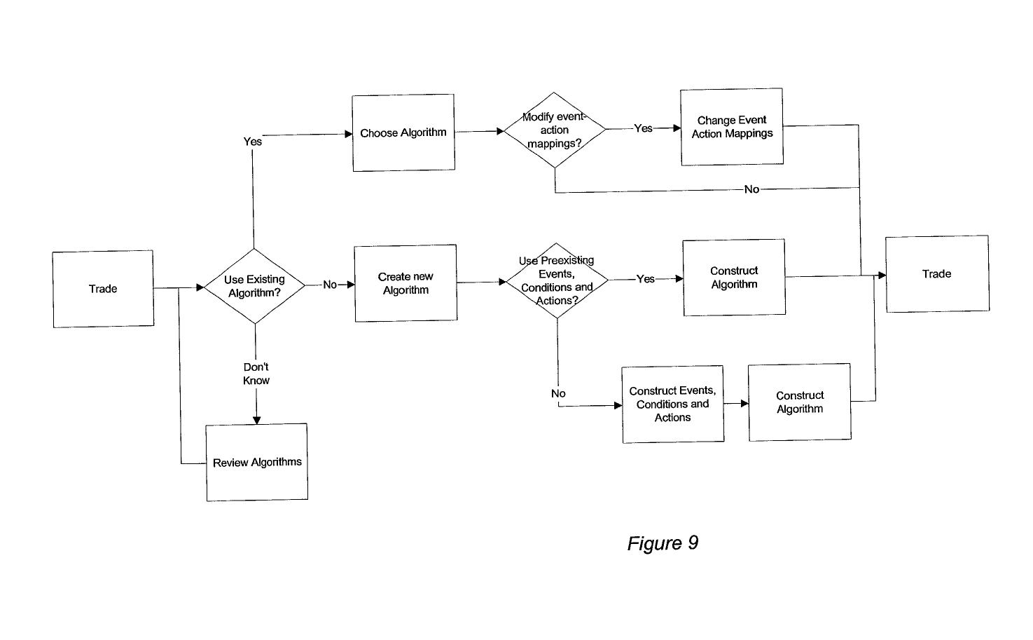

FIG. 8 provides a flowchart summarizing processes of a preferred embodiment, from installation to trading. FIG. 9 provides a flowchart summarizing a process for changing a plug-in. Other embodiments may have these processes or other processes with the same or similar steps in these or other orders.

The above description and the views and material depicted by the figures are for purposes of illustration only and are not intended to be, and should not be construed as, limitations on the invention.

Moreover, certain modifications or alternatives may suggest themselves to those skilled in the art upon reading of this specification, all of which are intended to be within the spirit and scope of the present invention as defined in the attached claims.

### APPENDIX A DETAILED

### Detailed Discussion of the References

In support of Applicant's petition under MPEP sec. 708.02 III, the following references were found and deemed most closely related to the subject matter encompassed by the claims of the above-identified application and are discussed infra. Copies of the following references accompany this petition.

1. U.S. Pat. No. 5,950,176 Keiser et al.

2. U.S. Pat. No. 5,918,218 Harris et al.

3. U.S. Pat. No. 6,134,535 Belzberg

1. U.S. Pat. No. 5,950,176 Keiser et al. (Keiser) Sep. 7, 1999

Keiser discloses a securities trading system that matches buy and sell orders of a security and then generates a market price for the security (see Abstract). A specialist is person who creates a market for a security by matching buyers with sellers and can influence the security's price by being a market participant.

The system described in Keiser reads in the buy order information, column 4 line 53—column 5 line 19, reads in sell order information, column 5 lines 20-33. The system then generates a market price based upon supply and demand of the security, column 5 lines 1-19.

If there is a mismatch between buy and sell orders of a give security, the system of Keiser buy or sell the security as a participant to make up the difference.

The present invention on the other hand, allows a user to implement and customize any one of a number of trading strategies by use of plug-ins. Keiser does not disclose or suggest plugging in and executing one or more trading strategies into an engine that provides trading services and therefore, implementing customized trading strategies. The system disclosed in Keiser is merely a virtual specialist or broker.

2. U.S. Pat. No. 5,918,218 Harris et al. (Harris), Jun. 29, 1999

Harris discloses a method for processing automated trading of mutual funds. The method of Harris allows benefit administrators to buy and sell mutual funds and accounting services to administrators and participants, column 2, lines 31-48. The system sends batch or “omnibus” trades to a transfer agent, column 3, lines 15-19. The system then provides an accounting for group of mutual fund trades from transfer agents, column 6, lines 64-67. Harris is an order entry and accounting system for mutual funds.

Harris does not disclose a means to detect and execute customized trading strategies within an engine structure. Instead, Harris discloses a system for bundling several mutual fund accounts, sending the orders to a transfer agent and then provides a verification and accounting of the transactions to administrators and fund owners.

3. U.S. Pat. No. 6,134,535 Belzberg, Oct. 17, 2000.

Belzberg discloses a graphical user interface (GUI) to select the parameters of a trade and a computerized trading system wherein a list of stocks are read-in from an exchange and entered into a spreadsheet, FIG. 4 and column 4 lines 56-62. Stocks are selected from the spreadsheet and then are formulated into an order, id.

Belzberg does not have a plug-in or other means for implementing trading strategies. Instead, the only data that is processed are the shares of stock or stocks to be bought or sold and does not allow customization of trading strategies.

The GUI in Belzberg, allows a user to select parameters such as price and size and transaction types such as buy or sell. However, Belzberg, does not implement multiple trading strategies and is merely an order entry system.

We claim:

1. An apparatus for computerized trading comprising:
a first plug-in for implementing a trading strategy,
a second plug-in for implementing a trading strategy,
an engine for providing services to either of said first or second plug-in,
whereby said first plug-in is implemented in said engine in order to execute a trade.

2. An apparatus as in claim 1, wherein said second plug-in is implemented in said engine in order to execute said trade.

3. An apparatus as in claim 1, wherein said first plug-in further comprises an algorithm plug-in that is implemented by the engine.

4. An apparatus as in claim 1, wherein said second plug-in further comprises a market plug-in that is implemented by the engine.

5. An apparatus as in claim 1, wherein the first and second plug-ins, and the engine, are constructed in Java.

6. An apparatus as in claim 1, further comprising a third plug-in whereby said third plug-in is substituted for said first plug-in in said engine.

7. An apparatus as in claim 2, further comprising a fourth plug-in whereby said fourth plug-in is substituted for said second plug-in in said engine.

8. An apparatus for computerized trading comprising:
a first, algorithm plug-in for implementing a trading strategy,
a second, market plug-in for implementing a trading strategy,
an engine for providing services to said first and second plug-ins, whereby said first and second plug-ins are implemented in said engine in order to execute a trade,
a third algorithm plug-in,
a fourth market plug-in,
whereby either of said third or fourth plug-ins may be substituted for either of said first plug-in or second plug-in respectively, in said engine, in order to execute a trade.

9. The apparatus of claim 8 wherein said first and third algorithm plug-ins implement trading strategies selected from a group comprising:
Volume Weighted Average Price;
Ratio;
Gamma Hedge;
Aggressive Short Sell;
Iceberg;
Auto Trader;
CB Delta Hedge;
Stop Loss; and
Short Sell.

10. A method for computerized trading comprising:
providing a first plug-in for implementing a trading strategy,
providing a second plug-in for implementing a trading strategy,
providing an engine for providing services to either of said first or second plug-ins, and,
executing a trade using said first plug-in implemented in said engine.

11. A method as in claim 10, wherein the step of executing a trade using said first plug-in implemented in said engine further comprises the step of using said second plug-in implemented in said engine in order to execute said trade.

12. A method as in claim 10, wherein the step of using said first plug-in implemented in said engine further comprises using an algorithm plug-in.

13. A method as in claim 11, wherein the step of using said second plug-in implemented in said engine further comprises using a market plug-in.

14. A method as in claim 10, wherein the steps of providing a first plug-in for implementing a trading strategy, providing a second plug-in for implementing a trading strategy, and providing an engine for providing services to either of said first or second plug-ins, further comprises providing Java versions of said first and second plug-ins and said engine.

15. A method as in claim 10, further comprising the step of providing a third plug-in.

16. A method as in claim 15, further comprising the step of substituting said third plug-in for said first plug-in in said engine.

17. A method as in claim 10, further comprising the step of providing a fourth plug-in.

18. A method as in claim 17, further comprising the step of substituting said fourth plug-in for said second plug-in.

19. A method for computerized trading comprising:
providing a first, algorithm plug-in for implementing a trading strategy,
providing a second, market plug-in for implementing a trading strategy,
providing an engine for providing services to either of said first or second plug-ins,
implementing said first and second plug-ins in said engine,
providing a third algorithm plug-in,
providing a fourth market plug-in, and
substituting either of said third or fourth plug-ins for either of said first plug-in or said second plug-in respectively, in said engine, in order to execute a trade.

20. A method as in claim 19, wherein the step of providing a first algorithm plug-in for implementing a trading strategy, further comprise providing a first algorithm plug-in selected from a group comprising:
Volume Weighted Average Price;
Ratio;
Gamma Hedge;
Aggressive Short Sell;
Iceberg;
Auto Trader;
CB Delta Hedge;
Stop Loss; and
Short Sell.

21. A method as in claim 19, wherein the step of providing a third algorithm plug-in for implementing a trading strategy, further comprise providing a third algorithm plug-in selected from a group comprising:
Volume Weighted Average Price;
Ratio;
Gamma Hedge;
Aggressive Short Sell;
Iceberg;
Auto Trader;
CB Delta Hedge;
Stop Loss; and
Short Sell.

22. The method of claim 19, further comprising the step of initiating a recovery mechanism in the event of system failure.

23. An article for executing computerized trading comprising:
a computer-readable signal bearing medium;
means in the medium for providing a first plug-in for implementing a trading strategy,
means in the medium for providing a second plug-in for implementing a trading strategy,
means in the medium for providing an engine for providing services to either of said first or second plug-in, whereby said first plug-in is implemented in said engine in order to execute a trade.

24. An article as in claim 23, further comprising means in the medium for providing a third plug-in for implementing a trading strategy.

25. An article as in claim 24, further comprising means in the medium for substituting said third plug-in for said first plug-in in said engine.

26. An article as in claim 23, further comprising means in the medium for providing a fourth plug-in for implementing a trading strategy.

27. An article as in claim 24, further comprising means in the medium for substituting said fourth plug-in for said second plug-in in said engine.
